(19) United States
(12) Patent Application Publication
(10) Pub. No.: US 2004/0200643 A1
(43) Pub. Date: Oct. 14, 2004

(54) Balance of precision

(76) Inventor: Lloyd P. Kissick, Tempe, AZ (US)

Correspondence Address: Tod R. Nissle, Esq., TOD R. NISSLE, P.C., P.O. Box 55630, Phoenix, AZ, 85078, US

(21) Appl. No.: 10/821,563

(22) Filed: Apr. 9, 2004

Related U.S. Application Data
(60) Provisional application No. 60/461,719, filed on Apr. 10, 2003.

(51) Int. Cl. G01G 21/00; G01G 23/14

(52) U.S. Cl. 177/126

(57) ABSTRACT

A balance of precision is provided that enables reduction of the number of auxiliary free weights required to measure the weights of objects over a selected weight range. The balance utilizes on the scale arm of the balance auxiliary free weights in conjunction with a weight that slides along the scale arm. The weight that slides along the scale arm is shaped and dimensioned to fit around an auxiliary free weight positioned on the scale arm.

This invention pertains to balances of precision.

More particularly, the invention relates to a balance of precision for measuring the weight of precious metals and stones and other articles.

In a further respect, the invention relates to a balance of precision that utilizes a reduced number of auxiliary free weights to enable the balance to weigh articles over a selected weight range.

In another respect, the invention relates to a balance of precision that minimizes the adverse affect of auxiliary free weights that extend above the fulcrum of the balance.

In still a further respect, the invention relates to a balance of precision that utilizes an auxiliary free weight that is in fixed position along a scale arm of the balance and that is operatively associated with a sliding weight that moves along the scale arm.

My U.S. Pat. No. 4,658,922 discloses a balance of precision that can be utilized to measure jewels, chemicals, and other articles. Some advantages of the balance are that it can be carried on the person, can be quickly prepared for transport in a protective house, and can be readily assembled and utilized to determine the weight of a quantity of precious metal or stones or other articles. One disadvantage of the balance is that it requires several auxiliary free weights to weigh articles having a mass of up to seven grams. Another disadvantage of the balance is that the auxiliary free weights are each configured such that the top portion of each weight extends above the fulcrum of the balance when the free weights are positioned on an arm of the scale. This tends to make the scale less stable than a configuration in which the center of gravity of the free weights is lower.

Accordingly, it would be highly desirable to provide an improved balance of precision that would require fewer auxiliary free weights to weigh articles having a mass in a selected range and that would minimize the adverse affect of portions of the free weights that extend above the fulcrum of the balance.

Therefore, it is a principal object of the invention to provide an improved balance of precision.

Another object of the invention is to provide an improved balance of precision that can utilize a reduced number of auxiliary free weights to achieve the ability to weigh articles in a selected weight range on the balance.

A further object of the invention is to provide an improved balance of precision that minimizes adverse forces generated by portions of auxiliary free weights that extend above the fulcrum of the balance of precision.

These and other, further and more specific objects and advantages of the invention will be apparent to those skilled in the art from the following detailed description thereof, taken in conjunction with the drawings, in which:

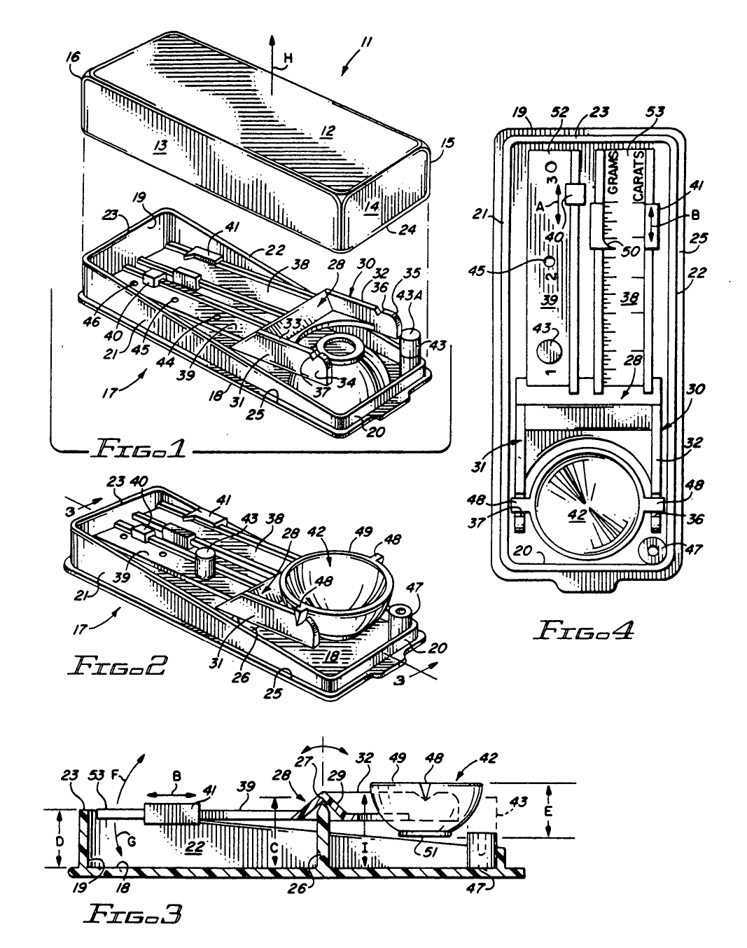

FIG. 1 is a perspective assembly view illustrating the balance of precision of U.S. Pat. No. 4,658,922;

FIG. 2 is a perspective view further illustrating the balance of precision of FIG. 1;

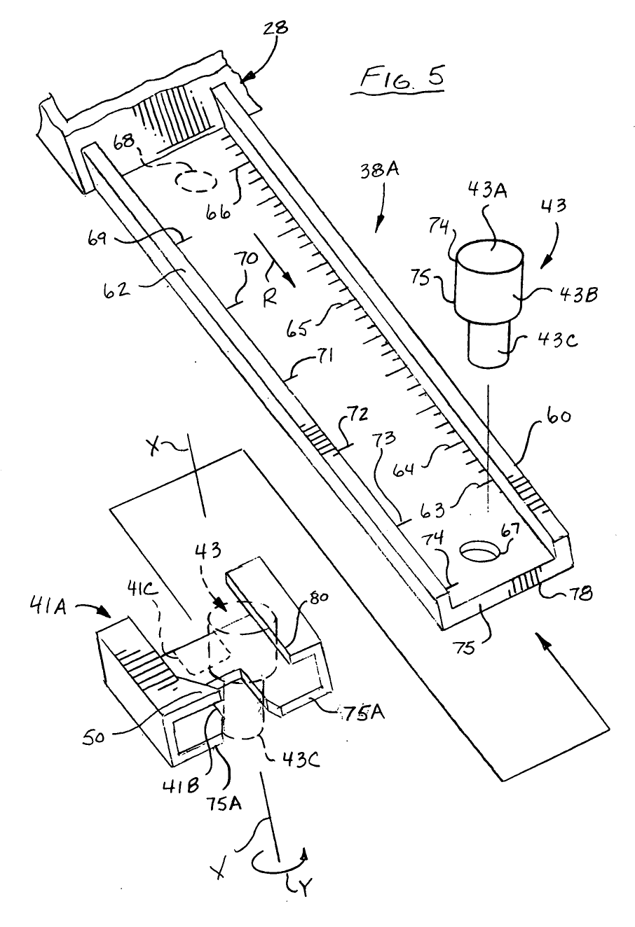

FIG. 3 is a section view of the balance of precision of FIG. 2 illustrating the position of the beam assembly thereof when the balance is in equipoise;

FIG. 4 is a top view of the balance of precision of FIG. 2;

FIG. 5 is a perspective assembly view illustrating an alternate construction in accordance with the invention of the scaled arm and accompanying weight of the balance of precision of FIG. 1.

Briefly, in accordance with my invention, I provide an improved balance of precision. The balance of precision includes at least one auxiliary free weight; an elongate base having a first end, second end, and a floor; a fulcrum connected to the base and having an elongate edge positioned a distance above the floor of the base; and, an elongate beam assembly position on the fulcrum for turning about the fulcrum edge. The beam assembly includes a member positioned over and including an elongate groove contacting the fulcrum edge to permit the member to turn about the edge; a pair of spaced apart support arms attached to and outwardly extending from the member and each having an elongate upper edge, an outer end, and a notch formed in said outer end thereof; a symmetrical pan having an upper lip, and a pair of ears extending outwardly from the pan, each ear normally rides in one of the notches such that the ear can turn in the notch and support the pan above the floor when the lever assembly is in equipoise; and, at least one scale arm attached to and outwardly extending from the member and having an outer end generally positioned between the fulcrum and the wall and adjacent and level with the upper edge of the wall when the beam assembly is in equipoise. The scale arm includes a measurement scale and weight slidably mounted thereon for balancing the beam assembly when the beam assembly is in equipoise. The scale arm generally is positioned below the fulcrum edge when the beam assembly is in equipoise. The elongate upper edges of the support arm are positioned above the fulcrum edge when the beam assembly is in equipoise. The pan has a height less than the shortest distance of the upper edges of the support arms above the floor beneath the upper edges when the beam assembly is in equipoise and being shaped, contoured, and dimensioned to be removed from the support arms, and stored on the portion of the floor of the base generally beneath and between the support arms. The balance of precision also includes a cover for the base. The cover has a top wall and side walls and is shaped and dimensioned to fit over and enclose the end wall of the base, the fulcrum, the support arms, and scale arms. The balance of precision includes a weight support arm extending from said body member, and a plurality of weight receiving stations formed on said arm. The balance of precision also includes at least one weight receiving station formed on the scale arm, and a slidable weight slidably mounted on the scale arm for adjustment therealong. The sliding weight includes an opening formed therein shaped and dimensioned to receive and fit around a portion of an auxiliary free weight inserted in the weight receiving station on the scale arm.

Turning now to the drawings, which depict the presently preferred embodiments of the invention for the purpose of illustrating the practice thereof and not byway of limitation of the scope of the invention, and in which like reference characters refer to corresponding elements throughout the several views, FIGS. 1 to 4 illustrate a balance of precision constructed according to my earlier issued U.S. Pat. No. 4,658,922 and including a protective housing having a hollow cover 11 having top wall 12, side walls 13-16. Side walls 15 and 16 are not visible and are parallel and equivalent in shape and dimension to walls 13 and 14, respectively. Cover 11 fits over base 17 which includes floor 18. End walls 19 and 20 and side walls 21 and 22 upwardly depend from floor 18. End wall 19 includes upper horizontal edge 23 parallel to floor 18.

When cover 11 is placed on base 17, walls 20-23 slidably fit within walls 13 to 16 of cover 11 and lower peripheral lip 24 of cover 11 circumscribes walls 20-23 and contacts lip 25 of base 17 circumscribing walls 20-23. Upstanding fulcrum 26 is integrally formed with floor 18 and includes upper horizontal knife-edge 27. Elongate triangular-shaped member 28 includes groove 29 which is shaped like an inverted “V” and pivtoally rides or turns on knife edge 27 of fulcrum 26. Support arms 30, 31 outwardly extend from member 28 and include upper edges 32 and 33 and outer ends 34 and 35. Notches 36 and 37 are formed in outer ends 35 and 34, respectively. Notches 36, 37 receive the lower knife-edges of ears 48 outwardly extending from pan 42.

The knife-edges of ears 48 permit pan 42 to pivot in notches 36, 37 and generally maintain under the force of gravity a position with upper circular edge 49 generally lying in an imaginary horizontal plane. Scale arms 38 and 39 outwardly extend from member 28. Arm 39 is provided with tare 40 which can be slidably adjusted along arm 39 in the direction of arrows A to zero balance the beam assembly of the balance.

Weight 41 is slidably mounted on arm 38 and is, after the beam assembly is zero balanced and an object is placed in pan 42, moved along arm 38 in the direction of arrows B until the beam assembly is in equipoise.

As shown in FIG. 4, weight measurement scales in grams and carats are inscribed on the surface of arm 38. If additional weight is desired on the side of fulcrum 26 to which arms 38, 39 extend, one or more auxiliary cylindrical free weights 43 can be inserted in one of apertures 44-46, with each aperture receiving one weight. The weight of each weight 43 is equivalent to that of each of the other weights; however, the shape and dimension and mass of the weights can vary as desired. For example, each weight 43 presently weighs one and one-quarter grams. Each weight 43 could instead weigh one gram, or five grams, or ten pounds, and so on. When not in use, an auxiliary free weight 43 is inserted in one or more holders formed in base 17. One such holder 47 is shown in FIGS. 1 to 4. Additional holders (not shown) can be located on the floor 18 of base 17 and centered between the two horizontally spaced arms 38 and 39. The additional holders extend upwardly from floor 18 and each have a recess shaped to receive the top 43A of a weight 43 when the weight is inverted.

Sliding weight 41 includes pointer 50. In FIG. 4, weight 41 and pointer 50 slide along the “grams” scale. In FIG. 2, weight 41 and pointer 50 is slide along the “carats” scale.

The entire beam assembly, including support arms 30, 31, member 28 and scale arms 38 and 39, can be lifted upwardly away from base 17 and off a fulcrum edge 27. After the beam assembly is lifted off fulcrum edge 27, weight 41 in FIG. 4 can be slide away from member 28 and off arms 38, rotated 180 degrees, and slid back onto arm 38 in the orientation shown in FIG. 2. Or, since there are five carats in one gram, it is a simple matter to convert from grams to carats, in which case weight 41 can continually be on arm 38 in the orientation shown in FIG. 4. Further, to prevent inadvertent loss of weight 41, once weight 41 is installed on arm 38 in the orientation shown in FIG. 4, the outer end of arm 38 can be provided with dimples or other structural features that prevent weight 41 from sliding completely off arm 38. These dimples cannot, however, when used in conjunction with weight 41A in FIG. 5, be in line with aperture 41B (or 41 C), but must be to the side of aperture 41B and contact edge 75A when weight 41A is positioned near distal end 75 of arm 38.

As shown in FIG. 1, pan 42 can be removed from support arms 30 and 31, turned upside down, and placed on floor 18 beneath and between arms 30 and 31 with circular lip 49 contacting floor 18.

In FIG. 3, arrows C indicate the shortest distance form floor 18 to fulcrum edge 27. Edge 27 is parallel to floor 18. Arrows D represent the shortest distance form floor 18 to upper horizontal edge 23 of wall 19. Arrows E represent the shortest distance between the bottom 51 and the horizontal imaginary plane passing through upper edge 49 of pan 42. Distances E and D are less than or equal to distance C.

Distances E and D being less than or equal to distance C permits pan 48 to be stored in the manner illustrated in FIG. 1 and permits edge 23 to be used in conjunction with ends 52 and 53 of arms 39 and 38, respectively, to determine when the balance is in equipoise. Arrows I represent the shortest distance from floor 18 to upper edges 32 and 33 when the beam assembly is in equipoise. Distance F is selected such that when cover 11 is placed on base 17 with peripheral edge 24 contacting edge 25, upper edges 32 and 33 generally contact top surface 12 on top wall 12. When edges 32 and 33 contact top wall 12 of cover 11, the beam assembly is immobilized on edge 27. Immobilization of the beam assembly by cover 11 helps prevent the beam assembly and knife edge from being damaged during transport if the balance of FIG. 1 is dropped or otherwise abused.

Conventional practice is to provide balance 11 with three weights 43. When there are not any weights 43 placed in the three openings labeled “1” (reference character 44), “2” (reference character 45), and “3” (reference character 46) in FIG. 4, then weight 41 can be slid in the directions indicated by arrow B to weigh an object having a weight of up to one gram.

When the weight 41 is positioned on arm 38 such that pointer 50 is positioned at the scale line furthest from body member 28 (i.e., is positioned on the scale line closest to the word “GRAMS” in FIG. 4), when there are no auxiliary free weights 43 on arm 39, and when the scale is in equipoise (i.e., arms 38, 39 are horizontally oriented and the arms 38 and 39, pan 42, and object in the pan 42 are balanced), then an object in pan 42 weighs one gram.

When sliding weight 41 is positioned on arm 38 such that pointer 50 is positioned at the scale line furthest from body member 28, when an auxiliary free weight 43 is in opening 44 in the manner shown in FIG. 2 (and auxiliary free weights 43 are not in openings 44, 46), and when the scale is in equipoise, then an object in pan 42 weighs two grams.

When sliding weight 41 is positioned on arm 38 such that pointer 50 is positioned at the scale line furthest from body member 28, when an auxiliary free weight 43 is in opening 45 (and not openings 44 and 46), and, when the scale is in equipoise, then an object in pan 42 weighs three grams.

When sliding weight 41 is positioned along arm 38 such that pointer 50 is positioned at the scale line furthest from body member 28, when an auxiliary free weight 43 is in opening 46 (and not openings 44 and 45), and when the scale is in equipoise, then an object in pan 42 weights four grams.

When sliding weight 41 is positioned along arm 38 such that pointer 50 is positioned at the scale line furthest from body member 28, when an auxiliary free weight 43 is in opening 44, when an auxiliary free weight is in opening 45, when an auxiliary free weight is not in opening 46, and when the scale is in equipoise, then an object in pan 42 weighs four grams.

When sliding weight 41 is positioned along arm 38 such that pointer 50 is positioned at the scale line furthest from body member 28, when an auxiliary free weight 43 is in opening 44, when an auxiliary free weight 43 is in opening 45, when an auxiliary free weight 43 is in opening 46, and when the scale is in equipoise, then an object in pan 42 weights seven grams.

Each weight 43 presently includes a circular top 43A, a cylindrical outer surface having a diameter greater than the diameter of each of openings 44 to 46, 67 and a cylindrical foot 43C having a diameter slightly less than that of cylindrical openings 44 to 46, 67 such that foot 43C will slidably removably fit in each opening 44 to 46, 67 to position weight 43 on arm 39 or 38A in the manner illustrated in FIG. 1.

Alternate embodiments of scale arm 38 and weight 41 are illustrated in FIG. 5 and are generally indicated by reference characters 38A and 41A, respectively. Arm 38A includes, as does arm 38, scale lines 69 to 73 indicating one (scale line 69), two (scale line 70), three (scale line 71), four (scale line 72) and five carats (scale line 73), and includes scale lines indicating one-tenth gram (line 66), five-tenths gram (line 65), nine-tenths gram (line 64), one gram (line 63), and so on. Arm 38A also includes scale line 74 indicating six carats. Aperture 67 is formed through arm 38A. An aperture 68 can also, if desired, be formed through arm 38A, as can apertures at any desired location along arm 38A. Sliding weight 41A is utilized in conjunction with arm 38A. The construction and shape and dimension of sliding weight 41A (and sliding weight 41) can vary as desired, but presently the construction of weight 41A is identical to that of weight 41, except that generally U-shaped opening 41B is formed in sliding weight 41A. Since the shape and dimension of weight 41A and weight 41 can vary as desired, weight 41A can, for example, take on the general shape and dimension of tare 40 (with a pointer like pointer 50 preferably incorporated in the tare 40) and slide along one rail 60 or 62 of arm 38A.

When weight 41A is slid onto arm 38A in the manner indicated in FIG. 5, pointer 50 will travel along the left hand side of arm 38A and travel along the carat scale comprised of scale lines 69 to 74. A particular advantage of sliding weight 41A is that when weight 41A is positioned along arm 38A such that pointer 50 is in registration with scale line 74 and the foot 43C of an auxiliary free weight 43 extends downwardly through aperture 67, opening 41B extends around the portion of foot 43C that extends through aperture 67 and out the rectangular bottom surface 78 of arm 38A. If opening 41B were not formed in weight 41A, then edge 75A of weight 41A would contact the portion of foot 43C extending through aperture 67 and weight 41A could not, after being positioned on arm 38 near body member 28, be slid in the direction of arrow R toward distal end 75 of arm 38 to a position at which pointer 50 is in registration with scale line 74. Edge 75A would, before pointer 50 could be moved into registration with line 74, contact the portion of foot 43C extending past bottom surface 78. Opening 41B solves this problem by having a width greater than the diameter of foot 43C and by fitting around foot 43C in the manner indicated by the ghost outline (dashed line outline) of an auxiliary free weight 43 depicted in FIG. 5.

When weight 41A is intended to be slid onto arm 38 in a configuration in which pointer 50 will travel along the gram scale that includes scale lines 63 to 66, then an aperture 41C can be formed in weight 41A. Aperture 41C preferably is shaped and dimensioned in a manner similar to that of aperture 41B such that aperture 41C extends around the portion of foot 43C extending downwardly past bottom surface 78 and permits weight 41A to be positioned such that pointer 50 is in registration with scale line 63 or is in registration with scale lines adjacent line 63 and intermediate line 63 and body member 28.

When a weight 43 is positioned in an aperture 44 to 46, 67and arms 38, 39, 38A are horizontally oriented, the top portion 74 of the weight 43 extends a distance above knife edge 27. This is not preferred because the portion of the weight extending about edge 27 is believed to introduce and generate forces that adversely affect the stability of the balance of the invention. One solution to this problem is to reduce the height of the top portion of weight that includes cylindrical outer surface 43B. This is somewhat impractical because it makes it difficult for an individual to manually grasp and manipulate the weight. Another potential solution is to alter the shape of body member 28 such that the arms 38 and 39 are attached to body member 28 at a point further below edge 27. This solution is also somewhat impractical because it increases the height of member 28 and of the cover 11 and therefore concomitantly increases the cost of manufacturing the balance. Still another potential solution is to shorten foot 28C so it does not extend downwardly past bottom 78. This solution is impractical because foot 43C, when so shortened, becomes too short and weight 43 is unstable when placed on an arm 39, 38A. The presently preferred embodiment of the invention depicted in FIG. 5 addresses this problem by minimizing at two the number of auxiliary free weights 43 required to measure up to seven grams of weight. In contrast, prior art scales typically require three auxiliary free weights 43.

In use of the balance of FIGS. 1 to 4, base 17 is placed on a level surface and cover 11 is removed from base 17 in the direction of arrow H in FIG. 1.The beam assembly, including components 38, 39, 28, 30, and 31, is lifted from fulcrum 26 and pan 42 is removed from floor 18. The beam assembly is placed back onto fulcrum 26 with notch 29 riding on edge 27 and the lower knife edges of ears 48 are positioned in slots 36 and 37 in the manner illustrated in FIGS. 2-4. Auxiliary cylindrical free weight 43 is positioned in holder 47. At least one other auxiliary cylindrical free weight 43 (in addition to the free weight 43 in holder 47) is provided in and is removed from base 17. None of auxiliary free weights 43 is placed in an aperture 44 to 46.

Weight 41 is slid along arm 38 toward member 28 until pointer 50 is at the zero reading on the grams scale. The zero reading is adjacent base member 28. Tare 40 is moved along arm 39 in the directions of arrows A until the beam assembly is in equipoise and ends 52 and 53 are level with upper edge 23 in the manner illustrated in FIG. 3. The object to be weighed is placed in pan 42, causing pan 42 to move downwardly and ends 52, 53 to move upwardly in the direction of arrow F in FIG. 3. Weight 41 is moved outwardly away from member 28 to cause ends 52 and 53 to move downwardly in the direction of arrow G. The position of weight 41 is adjusted along arm 38 until ends 52 and 53 are level with upper edge 23 of wall 19. The grams scale on arm 38 is read to determine the weight of the object in pan 42. If, after an object is placed in pan 42, weight 41 is slid outwardly away from the body member 28 to the outer end of the grams scale (near the word “GRAMS” in FIG. 4) and ends 52 and 53 are still positioned above edge 53, auxiliary free weight 43 can be removed from holder 47 and placed in aperture 44, 45, or 46 to provide the additional weight necessary to enable the beam assembly to be placed n equipoise by adjusting the position of weight 41 on scale arm 38. Or, if desired two or more auxiliary weights 43 can be utilized in apertures 44 to 46. As would be appreciated by those of skill in the art, the use of a balance of precision provided with the arm 38A—weight 41A construction of FIG. 5 in place of the arm 38—weight 41 construction, would be similar to the use described above in this paragraph. However, placing a weight 43 in aperture 67 is equivalent to placing a weight 43 in aperture 46, i.e., placing a weight 43 in aperture 67 presently increases by three grams the weight in arms 38A, 39 that is offsetting the weight of an object placed in pan 42. Further, since weight 41A is provided with apertures 41C and/or 41B, when a weight 43 is placed in aperture 67, weight 41A can still be moved along arms 38A such that pointer 50 is in registration with scale line 74 (when weight 41A is in one orientation on arm 38A, namely is in an orientation comparable to that of weight 41 in FIGS. 1 and 2) or with scale line 63 (when weight 41A is in the other orientation on arm 38A, namely is in an orientation comparable to that of weight 41 in FIG. 4). In particular, when a weight 43 is in aperture 67, when sliding weight 41A is in the first orientation shown in FIG. 5, and when weight 41A is slid along arm 38A to a position in which pointer 50 is in registration with scale line 74, then foot 43C fits in aperture 41B and aperture 41B extends around foot 43C. When a weight 43 is in aperture 67, when sliding weight 41A is in a second orientation (rotated about a vertical axis X by 180 degrees in the direction of arrow Y from the orientation shown in FIG. 5) and when weight 41A is slid along arm 38A to a position in which pointer 50 is in registration with scale line 63, foot 43C fits in aperture 41C and aperture 41C extends around foot 43C. In addition, the cylindrical outer surface 43B of auxiliary free weight 43 preferably has a diameter that is less than the distance from the tip of point 50 to edge 80 soh that surface 43B will fit and freely move therebetween.

The scales on an arm 38, 38A can be varied as desired. For example, a scale on an arm 38, 38A can indicate ounces instead of grams, or pounds instead of grams. The weight range of the balance of precision can vary as desired, and can, for example, be zero to tens grams, zero to ten pounds, etc. Altering the units of measure on a scale and the weight range of a scale ordinarily would require the construction of the balance of precision to be altered and the weight of each auxiliary free weight 43 to be altered. Such alterations are readily achieved by those of skill in the art.

Having described my invention in such terms as to enable those of skill in the art to make and practice it, and having described the presently preferred embodiments thereof, I claim:

1. A balance of precision including
(a) an elongate base having
(i) a first end and a second end; and
(ii) a floor;
(b) at least one auxiliary weight;
(c) a fulcrum connected to said base and having an elongate edge positioned a distance above said floor of said base;
(d) an elongate beam assembly positioned on said fulcrum for turning about said fulcrum edge, said beam assembly including
(i) a body member positioned over and including on elongate groove contacting said fulcrum edge to permit said member to turn about said edge,
(ii) a pair of spaced apart support arms attached to and outwardly extending from said member and each having
an elongate upper edge,
an outer end, and
a notch formed in said outer end thereof,
(iii) a symmetrical pan having
an upper lip, and
a pair of ears extending outwardly from said pan, each ear normally riding in one of said notches such that said ear can turn in said notch and support said pan above said floor when said lever assembly is in equipoise,
(iv) a first scale arm attached to and outwardly extending from said body member and having an outer end generally positioned between said fulcrum and said wall and adjacent and level with said upper edge of said wall when said beam assembly is in equipoise, said scale arm including
a measurement scale and weight slidably mounted thereon for balancing said beam assembly when said beam assembly is in equipoise,
an aperture formed in said measurement scale to receive removably said auxiliary weight.
